(19) United States
(12) Patent Application Publication
(10) Pub. No.: US 2024/0028966 A1
(43) Pub. Date: Jan. 25, 2024

(54) LEARNING PROGRAM, LEARNING METHOD, AND LEARNING DEVICE

(71) Applicant: NTT Communications Corporation, Tokyo (JP)

(72) Inventors: Satoshi TANAKA, Tokyo (JP); Yoichi SAKURAI, Tokyo (JP); Masashi SAWADA, Tokyo (JP)

(73) Assignee: NTT Communications Corporation, Tokyo (JP)

(21) Appl. No.: 18/372,145

(22) Filed: Sep. 25, 2023

Related U.S. Application Data
(63) Continuation of application No. PCT/JP2022/014701, filed on Mar. 25, 2022.

(30) Foreign Application Priority Data
Mar. 26, 2021 (JP) 2021-053128

(51) Int. Cl. G06N 20/00; G06F 21/60

(52) U.S. Cl. CPC G06N 20/00; G06F 21/602

(57) ABSTRACT

A non-transitory computer-readable recording medium stores therein a learning program that causes a computer to execute a process including calculating, by secure computation, an objective variable by inputting an explanatory variable into a logistic regression model, updating parameters of the logistic regression model by secure computation based on a result of calculation, and determining, by secure computation, whether to end update of the parameters based on whether an update amount of the parameters is smaller than a reference value that has been specified by a user and is encrypted.

### CROSS-REFERENCE TO RELATED APPLICATIONS

This application is a continuation application of International Application No. PCT/JP2022/014701, filed on Mar. 25, 2022 which claims the benefit of priority of the prior Japanese Patent Application No. 2021-053128, filed on Mar. 26, 2021, the entire contents of each are incorporated herein by reference.

### FIELD

The present invention relates to a learning program, a learning method, and a learning device.

### BACKGROUND

A secure computation system that performs statistical processing on data in an encrypted state has been known. For example, a technique of acquiring parameters in logistic regression analysis by using data in an encrypted state has been known (for example, refer to Non-Patent Literature 1).

In the following explanation, a regression coefficient and the like of a logistic regression model itself are referred to as model parameter. Moreover, processing of obtaining a model parameter by using training data, that is, a parameter set in training process is referred to as tuning parameter or hyperparameter.

Patent Literature 1: Japanese Laid-open Patent Publication No. 2020-042128

Non-Patent Literature 1: “System and Principles of Secure Computation”, rd.ntt/sc/project/data-security/NTT-himitsu-keisan.pdf, Last Accessed Date: Mar. 5, 2021

Non-Patent Literature 2: Naoto Kiribuchi, Dai Ikarashi, Koki Hamada, and Ryo Kikuchi: “MEVAL3: A Library for Programmable Secure Computation”, Symposium on Cryptography and Information Security (SCIS), 2018

Non-Patent Literature 3: Eizen Kimura, Koki Hamada, Ryo Kikuchi, Koji Chida, Kazuya Okamoto, Shirou Manabe, Tomohiro Kuroda, Yasushi Matsumura, Toshihiro Takeda, and Naoki Mihara: “Evaluation of Secure Computation in a Distributed Healthcare Setting”, Medical Informatics Europe (MIE) 2016: 152-156

Non-Patent Literature 4: Koji Chida, Gembu Morohashi, Hitoshi Fuji, Fumihiko Magata, Akiko Fujimura, Koki Hamada, Dai Ikarashi, Ryuichi Yamamoto: “Implementation and evaluation of an efficient secure computation system using ‘R’ for healthcare statistics”, J Am Med Inform Assoc. 21, pp. 326-331, 2014

However, the related techniques have a problem that there is a case in which adjustment of analysis accuracy according to an analysis subject is difficult in training process of logistic regression analysis by secure computation.

For example, in training of machine learning model including logistic regression model, there is a case in which update of a model parameter is repeated until convergence conditions are met.

In that case, among tuning parameters that determine the convergence conditions, there is one that is set in advance by a developer of a program for training, and cannot be adjusted by a user (analyst). Settings of the tuning parameters significantly affect the analysis accuracy of a trained logistic regression model.

Particularly, there is a case in which an update amount of a model parameter at a time being lower than a reference value is adopted as a convergence condition. On the other hand, in the technique described in Patent Literature 1, the reference value for an update amount of a model parameter cannot be set arbitrarily by a user.

### SUMMARY

It is an object of the present invention to at least partially solve the problems in the related technology.

According to an aspect of the embodiments, a non-transitory computer-readable recording medium stores therein a learning program that causes a computer to execute a process including: calculating, by secure computation, an objective variable by inputting an explanatory variable into a logistic regression model; updating parameters of the logistic regression model by secure computation based on a result of calculation; and determining, by secure computation, whether to end update of the parameters based on whether an update amount of the parameters is smaller than a reference value that has been specified by a user and is encrypted.

The above and other objects, features, advantages and technical and industrial significance of this invention will be better understood by reading the following detailed description of presently preferred embodiments of the invention, when considered in connection with the accompanying drawings.

### BRIEF DESCRIPTION OF DRAWINGS

FIG. 1 is a diagram illustrating a configuration example of an analysis system according to a first embodiment;

FIG. 2 is a diagram illustrating a configuration example of an analysis server according to the first embodiment;

FIG. 3 is a flowchart illustrating a flow of training process by the analysis system according to the first embodiment;

FIG. 4 is a flowchart illustrating a flow of analysis process by the analysis system according to the first embodiment; and

FIG. 5 is a diagram illustrating an example of a computer that executes learning program.

### DESCRIPTION OF EMBODIMENTS

Hereinafter, embodiments of a learning program, a learning method, and a learning device according to the present application will be explained in detail with reference to the drawings. The present invention is not limited to the embodiments explained below.

### First Embodiment

In a first embodiment, a learning program a learning method, and a learning device are implemented by a single function of an analysis system. The analysis system can perform training of a logistic regression model and analysis using a trained model by a technique of secure computation.

### Configuration of Analysis System of First Embodiment

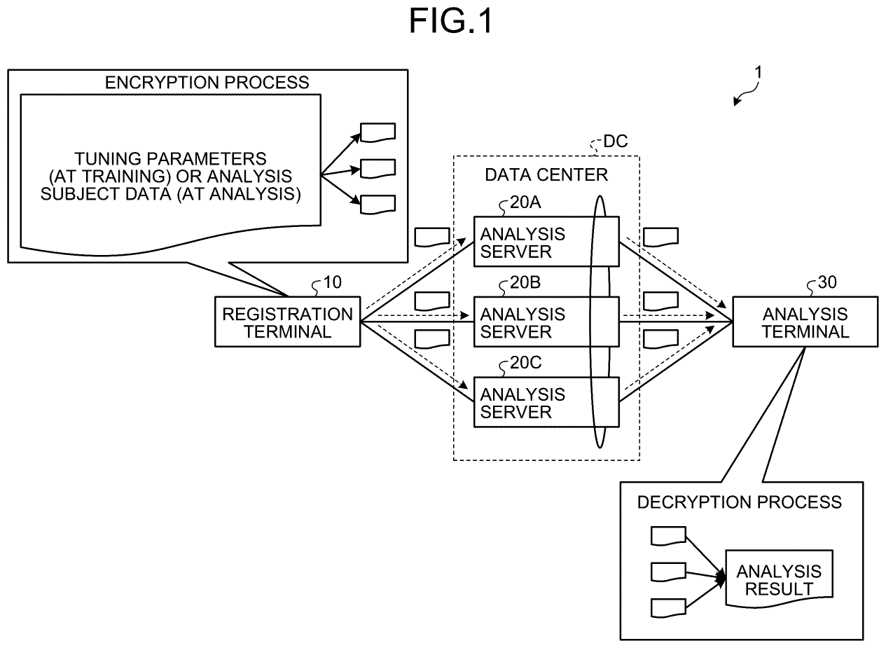

FIG. 1 is a diagram illustrating a configuration example of an analysis system according to the first embodiment. As illustrated in FIG. 1, an analysis system 1 includes a registration terminal 10, analysis server 20A, an analysis server 20B, an analysis server 20C, and an analysis terminal 30.

The respective analysis servers are equipped in a data center DC. Moreover, the number of analysis servers is not limited to the one illustrated in FIG. 1. Furthermore, in the following explanation, the analysis server 20A, the analysis server 20B, and the analysis server 20C may be referred to as analysis server group collectively.

The registration terminal 10 encrypts input data, and inputs it into the respective analysis servers. The input data is a tuning parameter to perform training of a logistic regression model, or analysis subject data.

For example, the registration terminal 10 performs encryption by fragmenting the input data into data called share, and by inputting the respective shares into different analysis servers, respectively, in a distributed manner (secret sharing). Each of the shares cannot be reconstructed individually.

Not limited to secret sharing, the registration terminal 10 can perform encryption by a method that can anonymize data, and that corresponds to a known secure computation technique.

The analysis server group perform secure computation by performing multiparty computation. For example, the analysis server group can perform training process of a logistic regression model by secure computation. Moreover, the analysis server group can perform calculation of an objective variable by secure computation, inputting analysis subject data into a trained logistic regression model as an explanatory variable.

The analysis terminal 30 decrypts an analysis result output from the respective analysis servers.

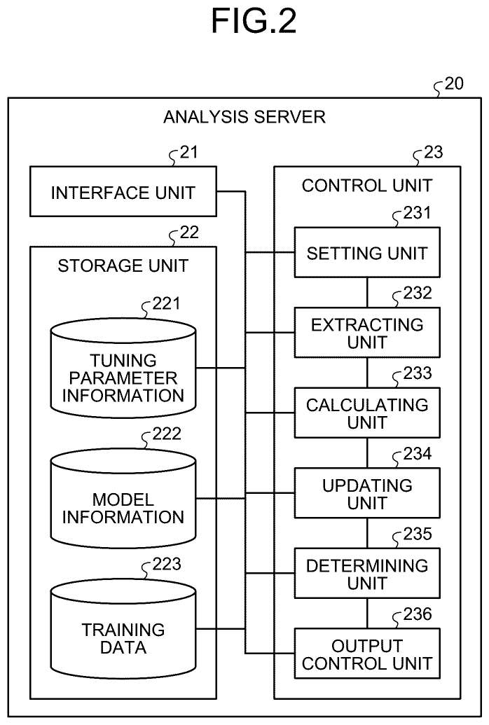

A configuration of an analysis server will be explained by using FIG. 2. FIG. 2 is a diagram illustrating a configuration example of an analysis server according to the first embodiment.

The respective analysis servers included in the analysis server group are not distinguished from one another, and denoted as analysis server 20. Moreover, the analysis server 20 functions as a learning device and an analysis device.

First, when the analysis server 20 functions as a learning device, the analysis server 20 accepts an input of tuning parameters of the analysis server 20. Moreover, the analysis server 20 can output an updated model parameter, and can transfer to other devices.

The tuning parameters include a learning rate, a maximum number of iterations, a batch size (batch or mini-batch), and a reference value of update amount. Details of the respective tuning parameters will be described later.

Next, when the analysis server 20 functions as an analysis device, the analysis server 20 accepts an input of analysis subject data. The analysis subject data includes an explanatory variable, an objective variable of which is unknown.

Respective components of the analysis server 20 will be explained. As illustrated in FIG. 1, the analysis server 20 includes an interface unit 21, a storage unit 22, and a control unit 23.

The interface unit 21 is an interface to input and output data. For example, the interface unit 21 is a network interface card (NIC). The interface unit 21 can communicate data with other devices.

Moreover, the interface unit 21 may be connected to an input device, such as a mouse and a keyboard. Furthermore, the interface unit 21 may be connected to an output device, such as a display and a speaker.

The storage unit 22 is a storage device, such as a hard disk drive (HDD), a solid state drive (SSD), an optical disk. The storage unit 22 may be a semiconductor memory that can rewrite data, such as a random access memory (RAM), a flash memory, a non-volatile static random access memory (NVSRAM). The storage unit 22 stores an operating system (OS) and various kinds of programs executed by the analysis server 20.

The storage unit 22 stores tuning parameter information 221 and model information 222. The tuning parameter information 221 is a default value of a tuning parameter. Moreover, the model information 222 is a model parameter to develop a logistic regression model explained later. For example, the model information 222 is a regression coefficient of the logistic regression model.

Training data 223 is a combination of an explanatory variable and an objective variable of ground truth. The training data 223 is supposed to be encrypted for secure computation.

The control unit 23 controls the entire analysis server 20. The control unit 23 is, for example, an electronic circuit, such as a central processing unit (CPU), a micro processing unit (MPU), and a graphics processing unit (GPU), or an integrated circuit, such as an application specific integrated circuit (ASIC) and a field programmable gate array (FPGA). Moreover, the control unit 23 has an internal memory to store a program in which various kinds of processing procedures are defined and control data, and performs various processing by using the internal memory.

The control unit 23 functions as various kinds of processing units as various kinds of programs operate. For example, the control unit 23 functions as a setting unit 231, an extracting unit 232, a calculating unit 233, an updating unit 234, a determining unit 235, and an output control unit 236.

First, processing of the setting unit 231, the extracting unit 232, the calculating unit 233, the updating unit 234, and the determining unit 235 when the analysis server 20 functions as a learning device will be explained.

The setting unit 231, the extracting unit 232, the calculating unit 233, the updating unit 234, and the determining unit 235 may be configured to perform each processing by a single function. In this case, arguments of the function include the tuning parameter.

The setting unit 231 performs settings of the tuning parameters. For example, the setting unit 231 stores an input tuning parameter in a predetermined variable in a function.

The extracting unit 232 extracts a mini match from the training data. For example, the extracting unit 232 performs extraction when the batch size of the tuning parameter is “mini batch”.

Calculation in the calculating unit 233, the updating unit 234, and the determining unit 235 is performed by secure computation.

The calculating unit 233 inputs the explanatory variable into the logistic regression model, and calculates the objective variable by secure computation. The calculating unit 233 calculates the objective variable by a function including a reference value specified by a user and encrypted, as an argument.

The calculating unit 233 calculates the objective variable by Equation 1.

f(\vec{x})=σ(\vec{w}·(1,\vec{x})) (1)

The left side of Equation 1 corresponds to the objective variable obtained by calculation. Moreover, σ is a sigmoid function. Furthermore, →w (→ right above w) is a regression coefficient of the logistic regression model. Moreover, →w can be regarded as a model parameter, and corresponds to the model information 222. →x is the explanatory variable.

The expression within the parentheses on the right side of Equation 1 can be expanded as Equation 2. Moreover, →w is expressed as Equation 3. Furthermore, →x is expressed as Equation 4.

\vec{w}·(1,\vec{x})=w₀+w₁x₁+w₂x₂+ . . . +wₙxₙ (2)

\vec{w}=x₁, x₂, . . . xₙ (3)

\vec{w}=w₀, w₁, . . . wₙ (4)

Moreover, the training data 223 is expressed as Equation 5. yᵢ is a ground truth of the objective variable. m is the number of individual data included in the training data 223, and i is a number to identify individual data included in the training data 223.

{\vec{x}ᵢ, yᵢ}ₘ(0≤i≤m) (5)

Moreover, an initial value of the model parameter of the logistic regression model is expressed as Equation 6.

\vec{w}ₜ₌₀ (6)

η in Equation 7 is the learning rate included in the tuning parameter.

η(0<η<1) (7)

T in Equation 8 is a maximum number of iteration included in the tuning parameter.

T(0<t<T) (8)

The updating unit 234 updates the model parameters of the Logistic regression model by secure computation based on the calculation result by the calculating unit 233. The updating unit 234 updates the model parameters by a function.

The updating unit 234 updates the model parameter as in Equation 9 at the t+1-th (range of t is as defined in Equation 8) update.

$$\begin{matrix}{w}_{j , t + 1} = {w}_{j , t} - η \frac{1}{m} {\sum }_{i = 0}^{m} ( {f ( {\vec{x}}_{i} )}_{t} - {y}_{i} ) {x}_{i , j} & ( 0 \leq j < n )\end{matrix} \qquad ( 9 )$$

The determining unit 235 determines whether to end the update of the model parameters based on whether the update amount of the model parameter by the updating unit 234 is smaller than the reference value specified by user. The determining unit 235 determines, by secure computation, whether to end the update of the model parameter by a function.

For example, when |wⱼ, ₜ₊₁−wⱼ, ₜ| (where | | is an absolute value) exceeds the reference value specified by the user, the determining unit 235 determines not to end the update of the model parameter.

On the other hand, when |wⱼ, ₜ₊₁−wⱼ, ₜ| does not exceed the reference value specified by the user, the determining unit 235 determines to end the update of the model parameters.

Moreover, when the determining unit 235 determines not to end the update of the model parameter, the calculating unit 233 performs more calculations. That is, when the convergence condition is not satisfied after the t-th update of the model parameter, the analysis server 20 performs the t+1-th update of the model parameter.

Next, processing of the processing unit 233 and the output control unit 236 when the analysis server 20 functions as an analysis device will be explained.

The calculating unit 233 inputs the explanatory variable into the logistic regression model developed based on the model information 222, and calculates the objective variable by secure computation.

The output control unit 236 outputs an analysis result based on the objective variable calculated by the calculating unit 233. For example, the output control unit 236 may output the objective variable as it is, or may output classification based on the objective variable or a result of determination.

### Processing of Analysis System of First Embodiment

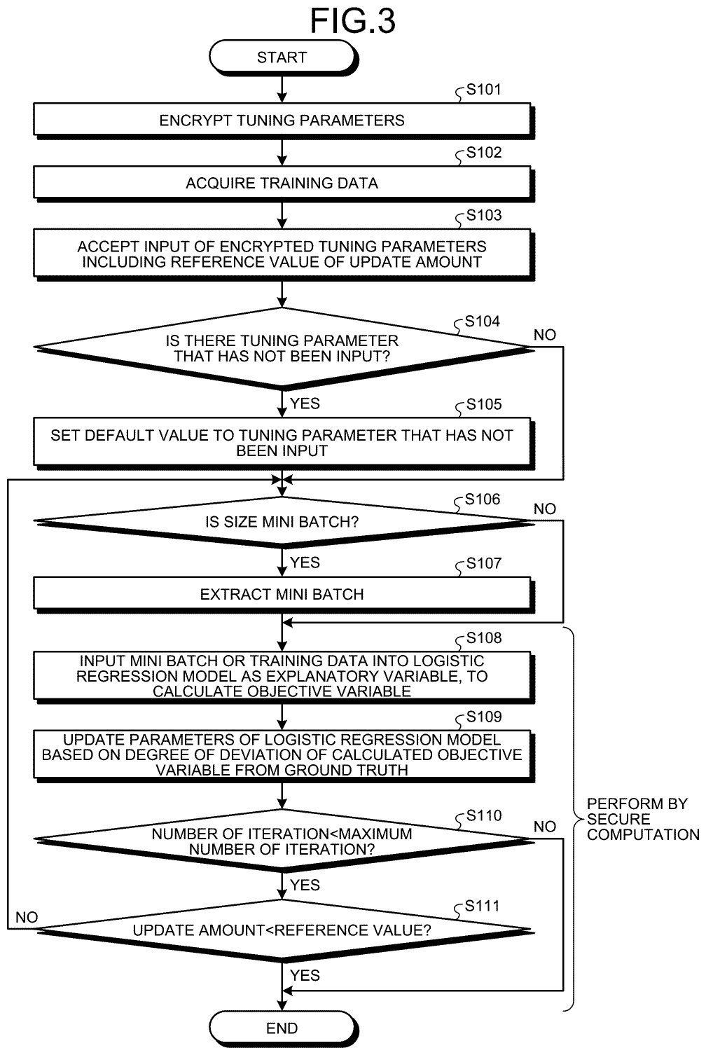

FIG. 3 is a flowchart illustrating a flow of training process by the analysis system according to the first embodiment. First, the registration terminal 10 encrypts the tuning parameters (step S101).

The analysis server 20 acquires the training data 223 from the storage unit 22 (step S102). At the same time, the analysis server 20 accepts an input of the encrypted tuning parameters including a reference value of an update amount (step S103).

The training data may be input as an argument of a function. Moreover, the training data and the tuning parameter may be acquired from a setting file that can be edited by the user, or the like.

There is a case in which all of or some of the tuning parameters are not input. Therefore, when there is a tuning parameter that has not been input (step S104: YES), the analysis server 20 sets a default value to the tuning parameter that has not been input (step S105). The analysis server 20 can acquire the default value of the tuning parameter from the tuning information 221.

On the other hand, when there is no tuning parameter that has not been input (step S104) NO), the analysis server 20 proceeds to step S106.

When the batch size specified as the tuning parameter is “mini batch” (step S106: YES), the analysis server 20 extracts a mini batch from the training data (step S107).

On the other hand, when the batch size specified as the tuning parameter is not “mini batch” (step S106: NO), the analysis server 20 proceeds to step S108.

The analysis server 20 performs the processing from step S108 to step S111 by secure computation.

The analysis server 20 calculates the objective variable by inputting the mini batch or the input training data into the logistic regression model as the explanatory variable (step S108).

The analysis server 20 can develop the logistic regression model based on the model parameters acquired from the model information 222.

The analysis server 20 updates the model parameters of the logistic regression model based on a degree of deviation of the calculated objective variable from a ground truth (step S109).

When the number of iteration from step S106 to step S109 is not smaller than the maximum number of iteration of the tuning parameters (step S110: NO), the analysis server 20 ends the processing.

On the other hand, when the number of iteration is smaller than the maximum number of iteration (step S110: YES), the analysis server 20 proceeds to step S111.

Furthermore, the update amount at step S109 is less than the reference value of the tuning parameter (step S111: YES), the analysis server 20 ends the processing.

On the other hand, when the update amount at step S109 is not less than the reference value (step S111: NO), the analysis server 20 returns to step S106 and repeats the processing.

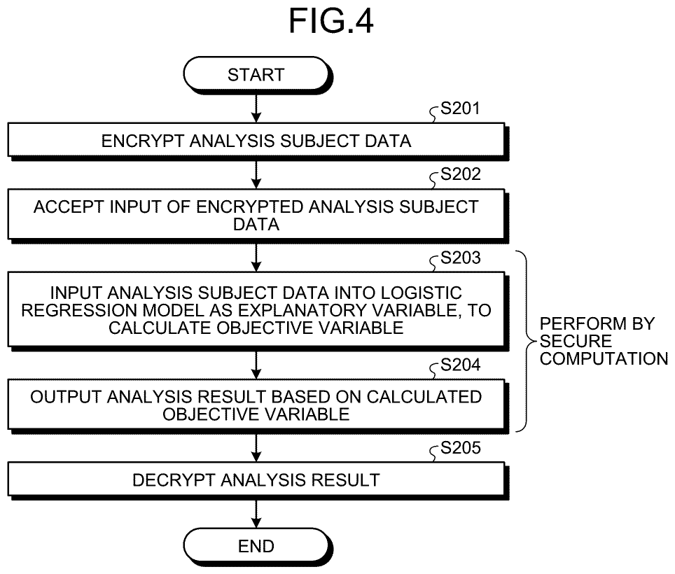

FIG. 4 is a flowchart illustrating a flow of analysis processing by the analysis system according to the first embodiment. As illustrated in FIG. 4, first, the registration terminal 10 encrypts the analysis subject data (step S201).

The analysis server 20 then accepts an input of the encrypted analysis subject data (step S202).

The analysis server 20 performs the processing at steps S203 and S204 by secure computation.

The analysis server 20 inputs the analysis subject data into the logistic regression model as the explanatory variable, to calculate the objective variable (step S203). The analysis server 20 outputs a result of analysis based on the calculated objective variable (step S204).

Furthermore, the analysis terminal 30 decrypts the result of analysis (step S205).

### Effects of First Embodiment

As explained above, the calculating unit 233 inputs an explanatory variable into the logistic regression model to calculate an objective variable by secure computation. The updating unit 234 updates model parameters of the logistic regression model based on a result of calculation by the calculating unit 233. The determining unit 235 determines whether to end update of the model parameters by secure computation based on whether an update amount of the model parameters by the updating unit 234 is smaller than a reference value that has been specified by a user and is encrypted.

As described, the analysis server 20 performs convergence determination based on the reference value of the update amount specified by a user. As a result, according to the present embodiment, adjustment of analysis accuracy according to an analysis subject is enabled in training process of a logistic regression model.

As described, in the present embodiment, any of calculation of an objective value, update of parameters, and determination whether to update can be performed by secure computation. Because results of the calculation, update, and determination remain encrypted and are not to be decrypted in the analysis server 20, it is possible to conceal the process and results of the processing.

In the present embodiment, as for a technique of secure computation, a method similar to the method described in Patent Literature 1 can be used.

Furthermore, tuning parameters including a reference value (maximum number of iteration) are also encrypted and, therefore, can be concealed.

The calculating unit 233 calculates an objective variable by a function including a reference value specified by a user as an argument. The updating unit 234 updates the model parameters by the function. The determining unit 235 determines whether to end the update of the model parameters by secure computation.

As described, by using the reference value of the update amount as an argument of the function, it is possible to accept specification by a user easily.

When the determining unit 235 determines that the update of the model parameter is not to be ended, the calculating unit 233 performs more calculations. Thus, the analysis accuracy of a model can be adjusted to an accuracy intended by the user.

### System Configuration Etc.

Moreover, the respective components of the respective devices illustrated are of functional concept, and it is not necessarily required to be configured physically as illustrated. That is, specific forms of distribution and integration of the respective devices are not limited to the ones illustrated, and all or some thereof can be configured to be distributed or integrated functionally or physically in arbitrary units according to various kinds of loads, usage conditions, and the like. Furthermore, as for the respective processing functions performed by the respective devices, all or an arbitrary part thereof can be implemented by a CPU and a computer program that is analyzed and executed by the CPU, or can be implemented as hardware by wired logic. The program may be executed by other processors such as a GPU, not limited to CPU.

Moreover, out of the respective processing explained in the above embodiments, all or some of processing explained to be performed automatically can also be performed manually, or all or some of processing explained to be performed manually can also be performed automatically by a publicly-known method. Besides, the procedure of processing, the procedure of control, the specific names, and the information including various kinds of data and parameters described in the above document or in the drawings can be arbitrarily changed, unless otherwise specified.

### Program

As one embodiment, the analysis server 20 can be implemented by installing a learning program that performs training process described above as package software of online software into a desired computer. For example, by causing an information processing device to execute the learning program described above, it is possible to make the information processing device function as the analysis server 20. The information processing device herein includes a desktop or laptop personal computer. Moreover, other than that, the information processing device includes a mobile communication terminal, such as a smartphone, mobile phone, and a personal handyphone system (PHS) and, furthermore, a slate device such as a personal digital assistant (PDA), and the like, falling within the category.

Moreover, the analysis server 20 can be implemented as a training server device that provide a service relating to the training process described above to a client, regarding a terminal device used by a user as the client. For example, the training server device is implemented as a server device providing a training service in which encrypted training data and tuning parameters are input, and trained model parameters are output.

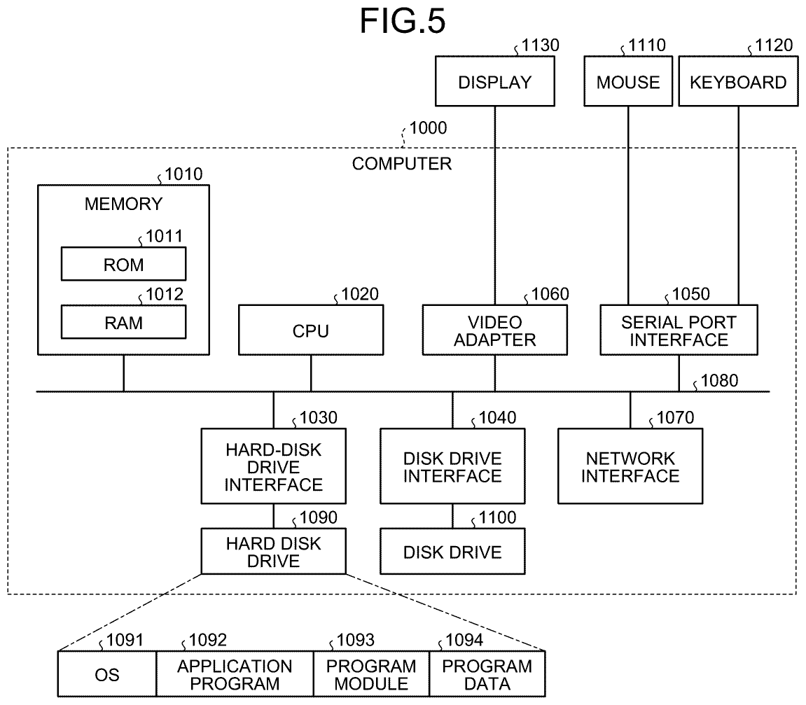

FIG. 5 is a diagram illustrating an example of a computer that executes the learning program. A computer 1000 includes, for example, a memory 1010 and a CPU 1020. Moreover, the computer 1000 includes a hard-disk drive interface 1030, a disk drive interface 1040, a serial port interface 1050, a video adapter 1060, and a network interface 1070. These respective components are connected through a bus 1080.

The memory 1010 includes a read only memory (ROM) 1011 and a random access memory (RAM) 1012. The ROM 1011 stores, for example, a boot program such as a basic input output system (BIOS). The hard-disk drive interface 1030 is connected to a hard disk drive 1090. The disk drive interface 1040 is connected to a disk drive 1100. For example, a detachable recording medium, such as a magnetic disk and an optical disk, is inserted into the disk drive 1100. A serial port interface 1050 is connected to, for example, a mouse 1110 and a keyboard 1120. A video adapter 1060 is connected to, for example, a display 1130.

The hard disk drive 1090 stores, for example, an OS 1091, an application program 1092, a program module 1093, and program data 1094. That is, a program that defines respective processing of the analysis server 20 is implemented as the program module 1093 in which computer-executable codes are described. The program module 1093 is stored in, for example, the hard disk drive 1090. For example, the program module 1093 to perform processing similar to functional configuration in the analysis server is stored in the hard disk drive 1090. The hard disk drive 1090 may be substituted by an SSD.

Furthermore, setting data used in the processing in the embodiment described above is stored in, for example, the memory 1010 or the hard disk drive 1090 as the program data 1094. The CPU 1020 loads the program module 1093 or the program data 1094 stored in the memory 1010 or the hard disk drive 1090 onto the RAM 1012 as necessary, and performs the processing of the embodiment described above.

The program module 1093 and the program data 1094 are not limited to be stored in the hard disk drive 1090, but may be stored in, for example, a detachable recording medium, and may be read by the CPU 1020 through the disk drive 1100 or the like. Alternatively, the program module 1093 and the program data 1094 may be stored in another computer that is connected through a network (local area network (LAN), wide area network (WAN), or the like). The program module 1093 and the program data 1094 may be read from the other computer by the CPU 1020 through the network interface 1070.

According to the present invention, adjustment of analysis accuracy according to an analysis subject can be performed in training process of a logistic regression model by secure computation.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A non-transitory computer-readable recording medium storing therein a learning program that causes a computer to execute a process comprising:
calculating, by secure computation, an objective variable by inputting an explanatory variable into a logistic regression model;
updating parameters of the logistic regression model by secure computation based on a result of calculation; and
determining, by secure computation, whether to end update of the parameters based on whether an update amount of the parameters is smaller than a reference value that has been specified by a user and is encrypted.

2. The non-transitory computer-readable recording medium according to claim 1, wherein
the calculating includes calculating the objective variable by a function including a reference value that has been specified by a user and is encrypted as an argument,
the updating includes updating the parameters by the function, and
the determining includes determining whether to end the update of the parameters by the function.

3. The non-transitory computer-readable recording medium according to claim 1, wherein the calculating is further performed when it is determined not to end the update of the parameters.

4. A learning method that is performed by a learning device, the learning method comprising:
calculating, by secure computation, an objective variable by inputting an explanatory variable into a logistic regression model;
updating parameters of the logistic regression model based on a result of calculation; and
determining, by secure computation, whether to end update of the parameters based on whether an update amount of the parameters is smaller than a reference value that has been specified by a user and is encrypted.

5. A learning device comprising:
processing circuitry configured to:
set a value specified by a user to a reference value;
calculate, by secure computation, an objective variable by inputting an explanatory variable into a logistic regression model;
update parameters of the logistic regression model by secure computation, based on a result of calculation; and
determine whether to end update of the parameters by secure computation, based on whether an update amount of the parameters is smaller than a reference value that has been specified by a user and is encrypted.
